(19) United States
(12) Patent Application Publication
(10) Pub. No.: US 2010/0034497 A1
(43) Pub. Date: Feb. 11, 2010

(54) Flexible Optical Pillars for an Optical Assembly

(75) Inventors: Alexei L. Glebov, San Mateo, CA (US); Michael G. Lee, San Jose, CA (US)

Correspondence Address: BAKER BOTTS L.L.P., 2001 ROSS AVENUE, SUITE 600, DALLAS, TX, 75201-2980, US

(73) Assignee: Fujitsu Limited, Kawasaki-shi (JP)

(21) Appl. No.: 12/186,020

(22) Filed: Aug. 5, 2008

(51) Int. Cl. G02B 6/12

(52) U.S. Cl. 385/14

(57) ABSTRACT

An optical assembly is provided that includes a substrate. The substrate has a set of one or more optical waveguides. A component is coupled to and spaced apart from the substrate by at least one or more mechanical supports. The component has one or more photodetectors. A set of one or more flexible optical pillars is disposed to be positioned between the set of optical waveguides and the photodetectors. The set of flexible optical pillars is optically transmissive and configured to transmit light from the set of optical waveguides to the photodetectors.

### TECHNICAL FIELD

This invention relates generally to optical devices and, more particularly, to flexible optical pillars for an optical assembly.

### BACKGROUND

Surface mount technology (SMT) for assembly of optical devices on various substrates is considered a reliable and cost effective technique. However, any displacement of components within an optical assembly may cause optical power loss, which can deteriorate the performance of the optical assembly. For example, a lateral shift may be caused by mechanical or thermal stresses, such as those caused by a coefficient of thermal expansion (CTE) mismatch. Such lateral shift may lead to misalignment of optical components, causing optical signal degradation or failure.

### SUMMARY OF THE DISCLOSURE

The present invention provides a method and system that substantially eliminates or reduces at least some of the disadvantages and problems associated with previous methods and systems.

According to one embodiment of the present invention an optical assembly is provided that includes a substrate that has a set of one or more optical waveguides. A component is coupled to and spaced apart from the substrate by at least one or more mechanical supports. The component has one or more photodetectors. A set of one or more flexible optical pillars is disposed to be positioned between the set of optical waveguides and the photodetectors. The set of flexible optical pillars is optically transmissive and configured to transmit light from the set of optical waveguides to the photodetectors.

Certain embodiments of the invention may provide one or more technical advantages. A technical advantage of one embodiment may include flexible optical pillars that transmit light. In contrast with other assembly structures that rely on free space propagation of light and coupling with microlenses, flexible optical pillars confine light to improve coupling efficiency.

Another technical advantage of one embodiment may include flexible optical pillars where the flexibility of the pillars restricts movement caused by, for example, the differences in the CTE of a component and a substrate in the assembly. Flexible optical pillars may restrict not only lateral movement but also vertical movement.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a diagram illustrating an example optical assembly;

FIG. 2 is a diagram illustrating the optical assembly of FIG. 1 with a flexible optical pillar, in accordance with one embodiment of the present invention;

FIG. 3A is a diagram illustrating an example optical assembly with flexible optical pillars disposed between the optical waveguides and the photodetectors, in accordance with one embodiment of the present invention;

FIG. 3B is a diagram illustrating flexible optical pillars compensating for the movement of the component with respect to the substrate, in accordance with one embodiment of the present invention;

FIG. 4 is a diagram illustrating flexible optical pillars and wirebond connections, in accordance with one embodiment of the present invention;

FIG. 5 is a diagram illustrating flexible optical pillars and flexible electrical connections, in accordance with one embodiment of the present invention;

FIG. 6 is a diagram illustrating flexible optical pillars and vertical-cavity surface-emitting lasers disposed on the component, in accordance with one embodiment of the present invention; and

FIG. 7 is a flow diagram illustrating an example method for providing an optical assembly, in accordance with one embodiment of the present invention.

### DETAILED DESCRIPTION OF THE DRAWINGS

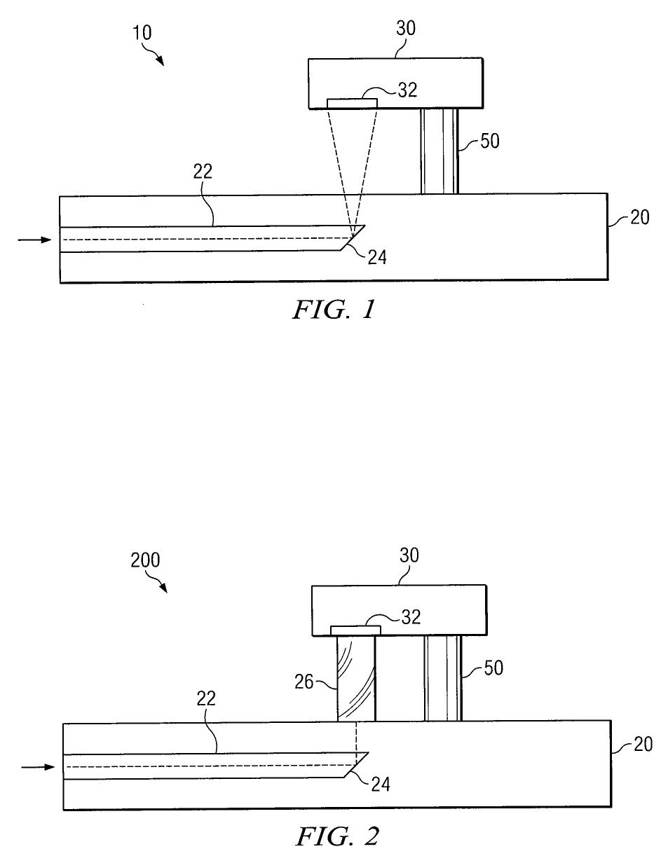

Embodiments of the present invention and its advantages are best understood by referring to FIGS. 1-7 of the drawings, like numerals being used for like and corresponding parts of the various drawings.

FIG. 1 is a diagram illustrating an example optical assembly 10. Optical assemblies, such as assembly 10, are devices in which one or more components (e.g., chips) are coupled to a substrate by one or more mechanical supports. The substrate has optical waveguides, which may transmit light to an array of photodetectors located on the component. However, any displacement within the optical assembly (such as a lateral shift of the component relative to the substrate) may cause optical power loss, which can deteriorate the performance of the optical assembly. For example, a lateral shift may be caused by mechanical or thermal stresses, such as those caused by a CTE mismatch between the substrate and the component. Such lateral shift may lead to misalignment of optical components, causing optical signal degradation or failure.

As described in more detail below in conjunction with FIGS. 2-7, a set of one or more flexible optical pillars may be positioned between the set of optical waveguides and the photodetectors. The flexible optical pillars are optically transmissive and configured to transmit light from the set of optical waveguides to the photodetectors. The flexible optical pillars may reduce light divergence and optical power loss. The flexible optical pillars may compensate for the movement of the component with respect to the substrate, thereby keeping the component and substrate optically coupled. Optically coupled, as it is referred to in this disclosure, refers to transmitting at least one light beam in an optical assembly from one structure to another structure in a manner that maintains the integrity of the light beam.

As shown in FIG. 1, assembly 10 includes a substrate 20 and a component 30. Substrate 20 is coupled to component 30 by one or more mechanical supports 50. It should be noted that although selected components are illustrated in FIGS. 1-6 at a high level, other materials and coupling techniques might be used. Moreover, the optical assemblies may include any other well-known components and the techniques described herein may be applied to many varieties of semiconductor assemblies such as component on component, electro-optic component on chip, and micro-electro-mechanical systems (MEMS) on chip, for example.

Substrate 20 may comprise any suitable surface and may comprise any suitable ceramic or organic material. For example, substrate 20 may refer to a base substrate that comprises a plastic surface mount for component 30 (also referred to as a package). As another example, substrate 20 may comprise a semiconductor chip that also acts as a substrate for component 30. In the illustrated embodiment, substrate 20 has one or more optical waveguides 22.

Waveguide 22 may refer to any suitable structure to propagate light. For example, waveguide 22 may include a structure integrated into substrate 20 with layers of different refractive indices to propagate light. Waveguide 22 includes at least one mirror 24 that redirects light. Mirror 24 may comprise any suitable material operable to reflect light. According to various embodiments, mirror 24 may be replaced with a grating or other element enabling light redirection.

Component 30 may comprise any suitable device operable to perform data processing. For example, component 30 may perform data transmission using electric signals. Component 30 may refer to a silicon chip, semiconductor chip, microelectronic chip, optoelectronic chip, MEMS chip, microchip die, integrated circuit, or any other suitable data processing device.

Component 30 has one or more photodetectors 32 that convert light to an electronic signal. According to various embodiments, component 30 and photodetector 32 are optically coupled to waveguide 22 on substrate 20. Thus, light from waveguide 22 and mirror 24 propagates in free space between substrate 20 and component 30 and is received at photodetector 32.

Mechanical support 50 may comprise any suitable material operable to couple component 30 and substrate 20. According to various embodiments, mechanical support 50 may comprise a polymer-based material, for example. According other embodiments, mechanical support 50 may comprise a solder bump comprised of any suitable conductive material such as gold, tin, lead, or copper, for example. According to yet other embodiments, mechanical support 50 may be replaced by other types of supports such as microelectronic interconnections, optical interconnections, or any other suitable support.

As described in more detail below, component 30 may move with respect to substrate 20, which may reduce the reliability of assembly 10. Any displacement of component 30 relative to substrate 20 may cause optical power loss. For example, a lateral shift of component 30 relative to substrate 20 may cause light divergence, which may deteriorate the performance of assembly 10. The lateral shift can be caused by mechanical or thermal stresses, as examples.

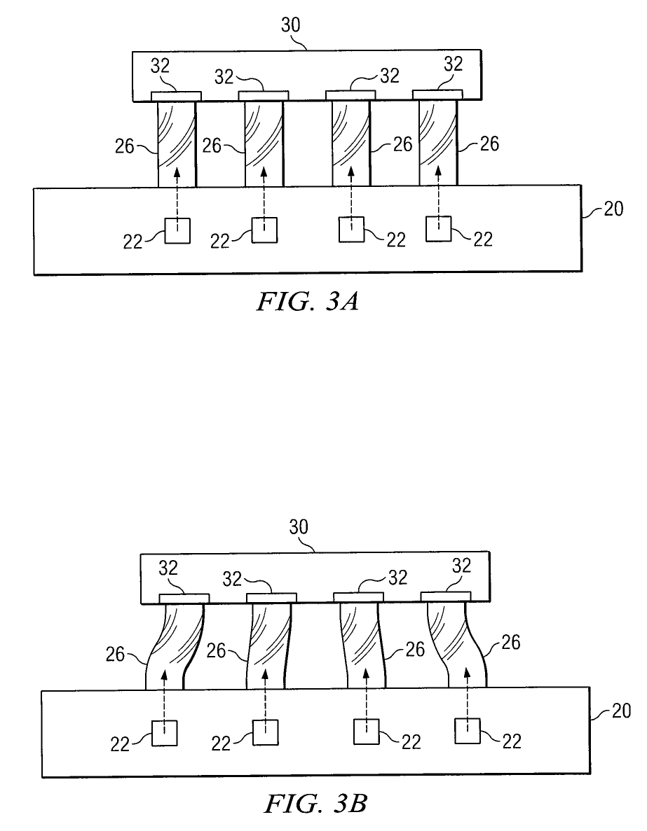

FIG. 2 is a diagram illustrating optical assembly 200 of FIG. 1 with a flexible optical pillar 26. According to particular embodiments of the present invention, flexible optical pillar 26 reduces light divergence. For example, flexible optical pillar 26 may comprise an optically transmissive protrusion disposed between optical waveguides 22 and photodetectors 32. Flexible optical pillar 26 is configured to transmit light from optical waveguide 22 to photodetector 32. According to one embodiment, flexible optical pillar 26 may compensate for the movement of component 30 with respect to substrate 20, thereby keeping component 30 and substrate 20 optically coupled. Keeping component 30 and substrate 20 optically coupled reduces optical power loss at assembly 200. Examples of the thin-film material and layering process are described in U.S. patent application Ser. No. 12/185,881 entitled “IMPROVING ALIGNMENT TOLERANCES FOR AN OPTICAL ASSEMBLY.” Further details of particular embodiments of the present invention are provided below with reference to FIGS. 3-7.

FIG. 3A is a diagram illustrating an example optical assembly with flexible optical pillars 26 disposed between optical waveguides 22 and photodetectors 32, in accordance with one embodiment of the present invention. According to one embodiment of the present invention, flexible optical pillars 26 may comprise a deformable material such as a polymer, photo-epoxy, or polysiloxane-based material, for example.

Flexible optical pillars 26 may have any suitable shape and dimensions. As an example only, flexible optical pillars 26 that are 150 um in height and 50 um in diameter may double the displacement tolerances (compared to the design of FIG. 1) when the distance between the waveguide and the photodetector is 50 um.

Moreover, although the illustrated embodiments in FIGS. 2-3B show flexible optical pillar 26 with a rectangular cross-section, flexible optical pillars 26 may have any suitable shape, such as a rounded, square, triangular, or polygonal cross-section. Indeed, the present disclosure contemplates many different shapes and compositions of flexible optical pillars 26. Various embodiments may include, some, all, or none of the enumerated shapes and compositions.

According to one embodiment of the invention, flexible optical pillars 26 may be disposed by photopatterning or etching. For example, a resist material may be deposited on substrate 20 and/or component 30. The resist material is then photopatterned to leave protrusions disposed on substrate 20 and/or component 30 that comprise flexible optical pillars 26.

According to another embodiment, flexible optical pillars 26 may be disposed on substrate 20 and/or component 30 by bonding each flexible optical pillar 26 with an epoxy or any other similar material. However, the present disclosure contemplates many types of techniques for disposing flexible optical pillars 26 on substrate 20 and/or component 30. Various embodiments may include, some, all, or none of the enumerated techniques.

FIG. 3B is a diagram illustrating flexible optical pillars 26 compensating for the movement of component 30 with respect to substrate 20, in accordance with one embodiment of the present invention. As described above, an optical assembly may suffer from stress caused by relative movement between component 30 and substrate 20. For example, a CTE mismatch may cause differences in expansion and contraction between substrate 20 and component 30. As illustrated in FIG. 3B, the contraction of component 30 relative to substrate 20 may result in light divergence and optical power loss if flexible optical pillars 26 are not used. It should be noted that the deformation of flexible optical pillars 26 illustrated in FIG. 3B may be exaggerated to aid in illustration.

According to one embodiment, the flexible optical pillars 26 may compensate for the movement of component 30 with respect to substrate 20, thereby keeping component 30 and substrate 20 optically coupled, thus reducing optical power loss. According to particular embodiments, flexible optical pillars 26 may have a high refractive index difference between the pillar material and air. Therefore, light may be confined in flexible optical pillars 26.

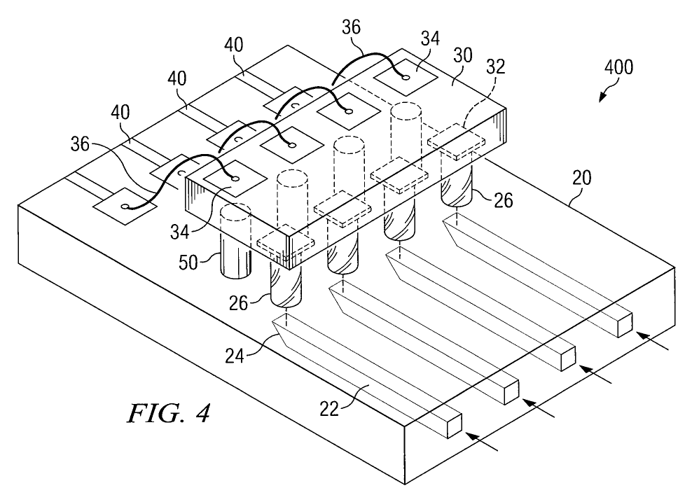

FIG. 4 is a diagram illustrating flexible optical pillars 26 and wirebond connections 36, in accordance with one embodiment of the present invention. Optical waveguides 22 with mirrors 24 are illustrated with light propagating in optical waveguides 22 and redirected by mirrors 24. Component 30 is coupled to substrate 20 using flexible optical pillars 26 and mechanical supports 50. Flexible optical pillars 26 are optically transmissive and are configured to transmit light from optical waveguides 22 to photodetectors 32. Mechanical supports 50 support assembly 400 mechanically. According to various embodiments, flexible optical pillars 26 and mechanical supports 50 may be fabricated in the same process from the same material. According to these embodiments, flexible optical pillars 26 and mechanical supports 50 may be flexible and may compensate for displacement.

In the illustrated embodiment, component 30 has photodetector bonding pads 34 on the surface of component 30. According to various embodiments, photodetector bonding pads 34 receive electrical signals from photodetectors 32 and transmit the electrical signals along wirebond connections 36 to electrical bonding pads 40 on the surface of substrate 20. For example, photodetectors 32 may be electrically connected to a chip, such as a driver chip, via wirebond connections 36. Wirebond connections 36 may comprise any suitable conductive material.

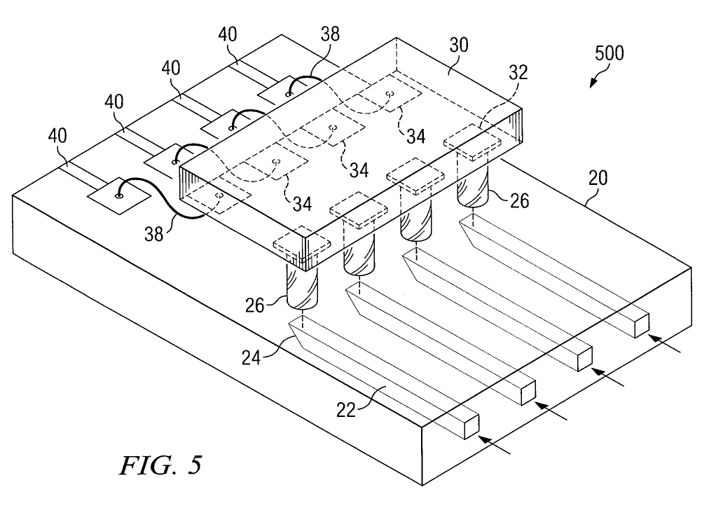

FIG. 5 is a diagram illustrating flexible optical pillars 26 and flexible electrical connections 38, in accordance with one embodiment of the present invention. In the illustrated embodiment, light is transmitted between substrate 20 and component 30 in a similar manner as described above with respect to FIG. 4. In this figure, mechanical supports 50 and wirebond connections 36 have been replaced by flexible electrical connections 38. As shown in the illustrated embodiment, photodetector bonding pads 34 are disposed on the bottom side of component 30 and flexible electrical connections 38 connect photodetector bonding pads 34 to electrical bonding pads 40 on the surface of substrate 20. Flexible electrical connections 38 may comprise, for example, wire springs, flexible metal foils, or any other suitable flexible conducting structures. In particular embodiments, flexible electrical connections 38 at least partially support component 30 and may partially reduce relative movement between component 30 and substrate 20.

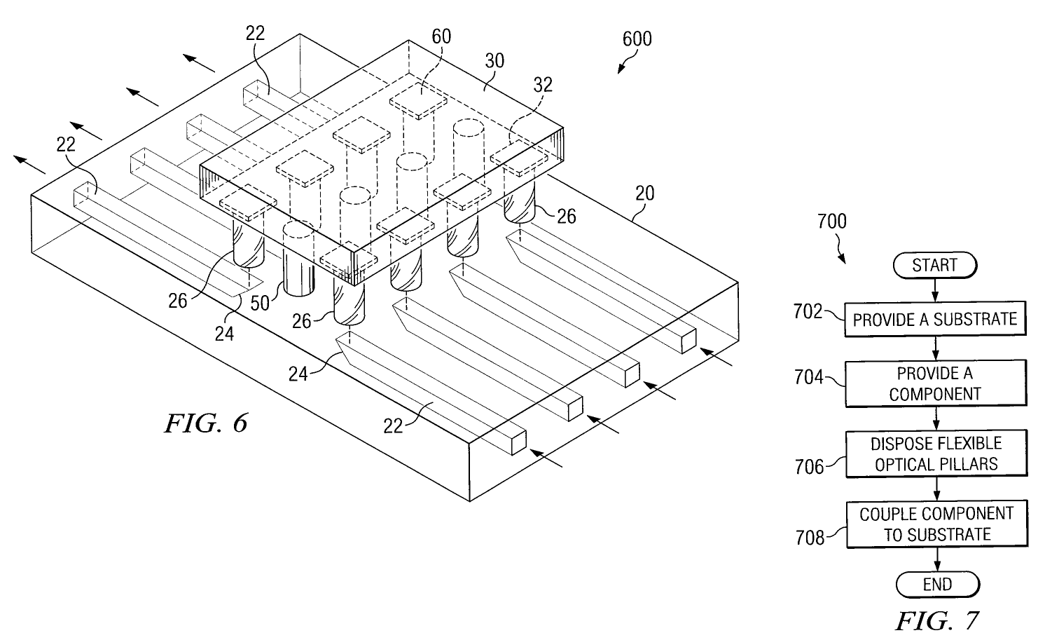

FIG. 6 is a diagram illustrating flexible optical pillars 26 and vertical-cavity surface-emitting lasers 60 disposed on component 30, in accordance with one embodiment of the present invention. Optical waveguides 22 with mirrors 24 are illustrated with light propagating in optical waveguides 22 and redirected by mirrors 24. Component 30 is coupled to substrate 20 using flexible optical pillars 26 and mechanical supports 50. Flexible optical pillars 26 are optically transmissive and are configured to transmit light from optical waveguides 22 to photodetectors 32. In this figure, the routing of the signals continues to vertical-cavity surface-emitting lasers 60, which transmit a light signal to a second set flexible optical pillars 26 disposed to be positioned between optical waveguides 22 and vertical-cavity surface-emitting lasers 60.

FIG. 7 is a flow diagram illustrating an example method 700 for providing an optical assembly, in accordance with one embodiment of the present invention. The example method begins at step 702 where a substrate is provided. For example, the substrate may refer to a base substrate that includes a plastic surface mount for a component (also referred to as a package). As another example, the substrate may include a semiconductor chip. The substrate may have a set of optical waveguides and each optical waveguide may include at least one mirror that redirects light. At step 104, a component is provided. According to one embodiment, the component has one or more photodetectors.

At step 106, a set of one or more flexible optical pillars are disposed on the component. According to one embodiment, the set of flexible optical pillars is optically transmissive and configured to transmit light from the set of optical waveguides to the photodetectors.

At step 108, the component is coupled to and spaced apart from the substrate by at least one or more mechanical supports. According to one embodiment, a CTE mismatch may cause differences in expansion and contraction between the substrate and the component. According to one embodiment, the flexible optical pillars may compensate for the movement of the component with respect to the substrate, thereby keeping the component and the substrate optically coupled, thus reducing optical power loss.

It should be understood that some of the steps illustrated in FIG. 7 may be combined, modified, or deleted where appropriate, and additional steps may be added to the flow diagram. Additionally, as indicated above, steps may be performed in any suitable order without departing from the scope of the invention.

Although the present invention has been described in detail with reference to particular embodiments, it should be understood that various other changes, substitutions, and alterations may be made hereto without departing from the spirit and scope of the present invention. For example, although the present invention has been described with reference to a number of components included within the optical assemblies, other and different components may be utilized to accommodate particular needs. The present invention contemplates great flexibility in the arrangement of these elements as well as their internal components.

Numerous other changes, substitutions, variations, alterations and modifications may be ascertained by those skilled in the art and it is intended that the present invention encompass all such changes, substitutions, variations, alterations and modifications as falling within the spirit and scope of the appended claims. Moreover, the present invention is not intended to be limited in any way by any statement in the specification that is not otherwise reflected in the claims.

1. An optical assembly, comprising:
a substrate, the substrate having a first set of one or more optical waveguides;
a component coupled to and spaced apart from the substrate by at least one or more mechanical supports, the component having one or more photodetectors; and
a first set of one or more flexible optical pillars disposed between the first set of optical waveguides and the photodetectors, the first set of flexible optical pillars being optically transmissive and configured to transmit light from the first set of optical waveguides to the photodetectors;
the mechanical supports and the flexible optical pillars all made of the same polymer material, the mechanical supports not being configured to transmit light to a photodetector.

2. The assembly of claim 1, wherein the first set of flexible optical pillars comprise polysiloxane.

3. The assembly of claim 1, wherein the first set of flexible optical pillars are disposed by photopatterning polysiloxane on the substrate.

4. The assembly of claim 1, further comprising one or more wirebond connections coupling one or more photodetector bonding pads disposed on the component to one or more electrical bonding pads disposed on the substrate.

5. The assembly of claim 1, further comprising one or more flexible electrical connections coupling one or more photodetector bonding pads disposed on the component to one or more electrical bonding pads disposed on the substrate, wherein the flexible electrical connections at least partially support the component.

6. (canceled)

7. The assembly of claim 1, wherein the substrate comprises a base substrate and the component comprises a silicon chip.

8. The assembly of claim 1, the substrate having a second set of one or more optical waveguides, the component having one or more vertical-cavity surface-emitting lasers, the assembly further comprising a second set of one or more flexible optical pillars disposed to be positioned between the second set of optical waveguides and the vertical-cavity surface-emitting lasers, the second set of flexible optical pillars being optically transmissive and configured to transmit light from the vertical-cavity surface-emitting lasers to the second set of optical waveguides.

9. A method for providing an optical assembly, comprising:
providing a first element and a second element;
photopatterning a first set of one or more flexible optical pillars of a polymer material on the second element, the first set of flexible optical pillars being optically transmissive and configured to transmit light from the first element to the second element; and
photopatterning one or more mechanical supports of the polymer material on the second element, the mechanical supports coupling the second element to and spaced apart from the first element, the mechanical supports not being configured to transmit light to the second element.

10. The method of claim 9, wherein the first set of flexible optical pillars comprise polysiloxane.

11. (canceled)

12. The method of claim 9, further comprising coupling one or more photodetector bonding pads disposed on the second element to one or more electrical bonding pads disposed on the first element with one or more wirebond connections.

13. The method of claim 9, further comprising coupling one or more photodetector bonding pads disposed on the second element to one or more electrical bonding pads disposed on the first element with one or more flexible electrical connections, wherein the flexible electrical connections at least partially support the second element.

14. (canceled)

15. The method of claim 9, wherein the first element comprises a base substrate and the second element comprises a silicon chip.

16. The method of claim 9, wherein the second element comprises a base substrate and the first element comprises a silicon chip.

17. The method of claim 9, the first element having a set of one or more optical waveguides, the second element having one or more vertical-cavity surface-emitting lasers, and further comprising disposing a second set of one or more flexible optical pillars on the second element, the second set of flexible optical pillars being optically transmissive and configured to transmit light from the vertical-cavity surface-emitting lasers to the second set of optical waveguides.
